(19) United States
(12) Patent Application Publication
(10) Pub. No.: US 2023/0158414 A1
(43) Pub. Date: May 25, 2023

(54) FOUNTAIN ASSEMBLY

(71) Applicant: PLAYFOUNTAIN B.V., Soest (NL)

(72) Inventors: Guido Molenaar, Amersfoort (NL); Frank Van Den Berg, Eindhoven (NL)

(21) Appl. No.: 17/917,459

(22) PCT Filed: Apr. 7, 2021
(86) PCT No.: PCT/EP2021/059003

§ 371 Date: Oct. 6, 2022

(30) Foreign Application Priority Data
Apr. 9, 2020 (EP) 20169048.4

(51) Int. Cl. A63G 31/00; B05B 17/08

(52) U.S. Cl. CPC A63G 31/007; B05B 17/08

(57) ABSTRACT

A fountain assembly, such as a play fountain, comprising one or more rechargeable power packs, each power pack comprising at least one power storage element, such as one or more supercapacitors. The fountain assembly further comprises a controller configured to continuously maintain the stored power of the power storage elements at or above a predefined level during operation.

### CROSS-REFERENCE TO RELATED APPLICATION(S)

This Application is a Section 371 National Stage Application of International Application No. PCT/EP2021/059003, filed Apr. 7, 2021 and published as WO 2021/204841 A1 on Oct. 14, 2021, in English, and further claims priority to European patent application number 20169048.4, filed Apr. 9, 2020, the contents of which are hereby incorporated by reference in their entirety.

### BACKGROUND

The discussion below is merely provided for general background information and is not intended to be used as an aid in determining the scope of the claimed subject matter.

The invention relates to a fountain assembly, in particular a play fountain, comprising a floor with a plurality of nozzles, a plurality of pumps feeding the nozzles for generating jets of liquid, in particular water, and a control system for operating the pumps and nozzles. The jetted liquid is typically contained in a reservoir, the pumps being arranged to pump the liquid from the reservoir to the respective nozzles. The pumps or nozzles can be controlled individually to generate a specific pattern of jets and possibly with different jet heights or intensities. This pattern may vary over time, e.g., continuously or intermittently. Examples of play fountains are disclosed in WO 2012/003951, WO 2014/147218 and WO 2018/087716.

Electrical power consumed by play fountains fluctuates with the number and intensity of simultaneously activated jets, resulting in substantial power peaks. To cope with these peaks, WO 2014/147218 teaches to power the pumps via rechargeable batteries. However, after discharge rechargeable batteries need time for recharge, so the jetting patterns must be selected such that discharged batteries have sufficient time to be recharged.

### SUMMARY

A fountain assembly comprises one or more rechargeable power packs, each power pack comprising at least one power storage element, wherein the fountain assembly further comprises a controller configured to continuously maintain the stored power of the one or more power storage elements at or above a predefined level during operation. It was found that this resulted in a considerably more flexible power management.

In a specific embodiment, the fountain assembly can comprise a plurality of power packs interconnected so as to allow direct power exchange between the power packs. In such a configuration, the power packs jointly perform as if they were a single power source.

The stored power and the power supplied from a source, such as a generator or the mains, should jointly be sufficient to run the fountain assembly as a whole. For example, the mains or a generator may cover the average power consumption, while the power stored in the power packs covers all additional power consumption.

In a specific embodiment, each power pack feeds a plurality of electric motors for controlling water jets, valves for controlling water jets and/or light sources. One or more of the power packs may for example comprise at least one power storage element storing electric energy, such as a capacitor or a superconducting magnetic energy storage (SMES). A capacitor is an element storing electric energy electrostatically, as opposed to electrochemical energy storage used in other types of rechargeable batteries. Although the energy density of capacitors is notoriously low compared to other types of rechargeable batteries, it was found that they are very suitable for dealing with peaks in power consumption. Recharge time is very short, about as long as the discharge time.

Alternatively, other types of energy storage can be used, such as flywheels.

In a specific embodiment, the individual power storage elements have a capacitance of at least 1 farad, e.g., at least 100 farad, e.g., at least 300 farad. Particularly suitable capacitors are for example supercapacitors or ultracapacitors, such as double layer capacitors, pseudocapacitors and/or hybrid capacitors, such as lithium-ion capacitors, or combinations thereof. Supercapacitors, or ultracapacitors, are capacitors using electrostatic double-layer capacitance and electrochemical pseudocapacitance, both of which contribute to the total capacitance of the capacitor. In a particular embodiment, one or more of the power packs may contain at least two supercapacitors, e.g., 4-6 supercapacitors.

In a specific embodiment, the fountain assembly may comprise a plurality of power packs connected in parallel to an external power source, such as the mains or a power generator, for instance by means of a junction cabinet. The junction cabinet may typically comprise a casing shielding connection points for receiving connectors of cables feeding the power packs. For safety reasons the casing may comprise a security lock locking the casing as long as the connected capacitors are still wholly or partly charged. The casing may also comprise an indicator lamp or a voltmeter.

The individual power packs may feed an associated indicator lamp or a resistor. If the power pack is not yet fully discharged, and the fountain is not used and the junction cabinet is not fed from an external source, such as the mains, the indicator lamp or resistor will slowly exhaust the power pack. When the indicator lamp goes out, this means that the power packs are completely discharged and the junction cabinet casing can be opened safely, e.g., to plug-in a connector of a new power pack.

Furthermore, the fountain assembly may comprise a power supply unit reducing the voltage of the power fed to the junction cabinet and/or power packs, e.g., in accordance with local regulations or industrial standards, e.g., to a voltage below 30 V, e.g., below 15 V, e.g., 13 V or lower.

Optionally, the fountain assembly may comprise a load bearing floor comprising interchangeable floor modules, each floor module comprising a tile with a plurality of nozzles, each nozzle being operatively connected to a pump or valve, powered by one of the power packs. The pumps and/or power packs can for example be suspended from a lower side of the tile, or they can be separate from the floor module.

In a further embodiment, each power pack is operatively connected to an auxiliary controller controlling activation of the electric motors and/or valves of the associated floor module, for example in addition to a main controller controlling the fountain assembly as a whole. With such an arrangement the play fountain is controlled on two levels: the main controller determines the pattern and activates the respective floor modules. In turn, the auxiliary controller of the floor module activates the respective pumps or nozzles to produce jets of the desired intensity and pulse lengths. Jointly, the main and auxiliary control are arranged to operate the electric motors or nozzles to generate a succession of different jet patterns, e.g. moving walls or changing mazes of liquid jets on the play fountain. The main control is arranged to select these jet patterns from a database or it can generate the jet patterns itself.

A modular build-up of the fountain assembly, e.g., a play fountain, makes it possible to install the assembly either permanently or temporarily, e.g. during events or for a few months in summer, and the size and shape of the floor can be varied. Configurations can be easily adapted.

The power packs can be housed in a waterproof casing, e.g., each power pack, or assembly of multiple power packs, being packed in a sealed box.

The fountain assembly may for example comprise a reservoir underneath the floor, e.g., extending underneath the entire floor. Thus, the individual pumps suck the water from the reservoir and deliver it to the nozzles.

Optionally, the assembly can be configured to control the direction of the jets and/or to control light sources to provide a light show. Optionally, the fountain assembly can also be configured to include air blasts, e.g., using air nozzles connected to a source of pressurized air.

The disclosure further pertains to a fountain assembly comprising a plurality of nozzles and pumps, at least one of the pumps and/or nozzles being powered by power packs comprising at least one capacitor, such as a supercapacitor.

### BRIEF DESCRIPTION OF THE DRAWINGS

The invention will be further explained with reference to the accompanying drawings, showing an exemplary embodiment.

FIG. 1: shows schematically a play fountain assembly;

FIG. 2A: shows in bottom view a floor module of the play fountain assembly of FIG. 1;

FIG. 2B: shows the floor module of FIG. 2A in side view;

FIG. 3: shows in more detail a power pack of the floor module of FIG. 2A, with the casing partly broken away;

FIG. 4: shows the control unit and the junction cabinet of the play fountain in FIG. 1.

### DETAILED DESCRIPTION

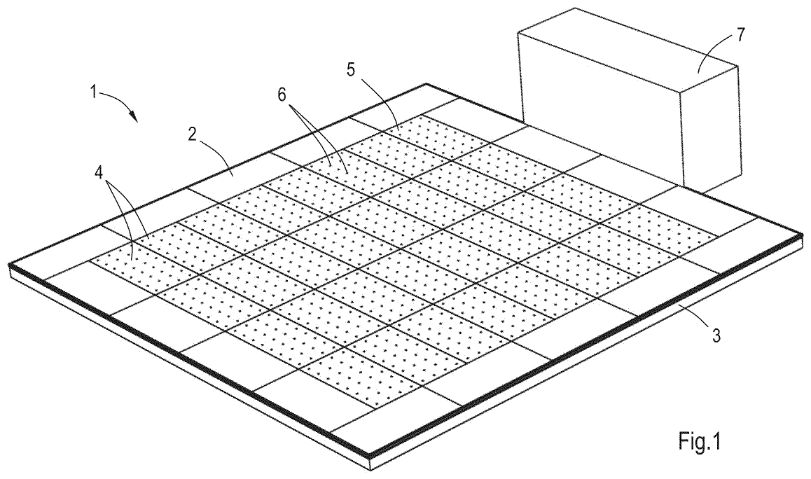

FIG. 1 shows a play fountain 1 comprising a walkable floor 2 covering a reservoir 3. The floor 2 has a modular set-up and comprises connecting interchangeable floor modules 4. Each one of the floor modules 4 comprises a tile 5 with a walkable upper surface provided with an array of nozzles 6. The floor 2 is designed for carrying a weight load by multiple playing and running people.

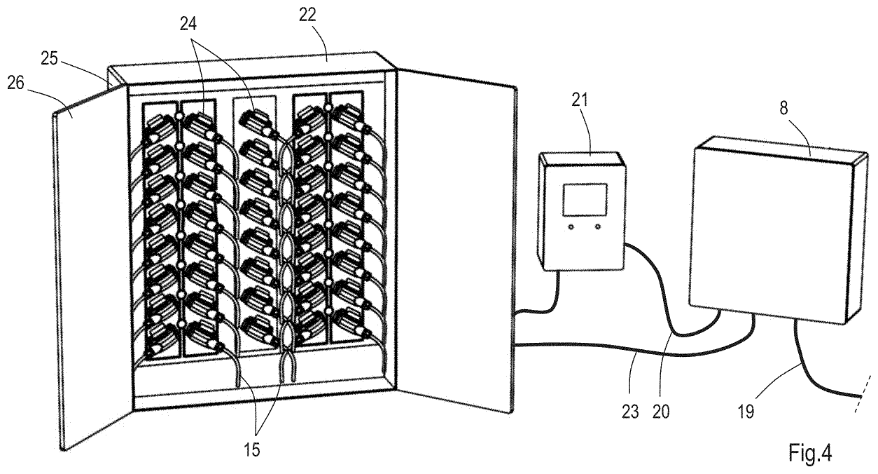

The play fountain 1 also comprises a plant room 7 containing a main controller 8, a junction cabinet 9 (see FIG. 4) and a filter system (not shown) for recirculating, filtering water to be recycled to the reservoir 3, and for dosing a sanitizing agent, such as for example hydrogen peroxide or chlorine.

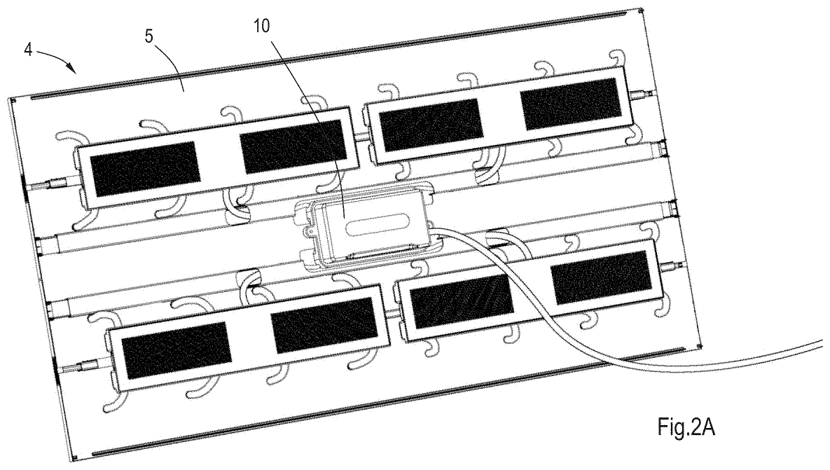

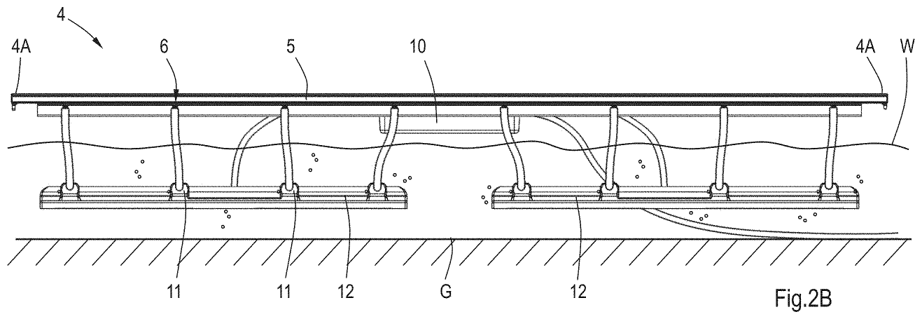

FIG. 2A shows the bottom side of an individual floor module 4, shown in side view in FIG. 2B. The floor module 4 comprises a power pack 10 in a water tight casing and a series of pumps 11 arranged on beams 12 spacing the pumps 11 from the lower side of the tile 4. In the shown embodiment, the floor module comprises eight pumps 11, each pump 11 communicating with four nozzles 6. Alternative embodiments may comprise different. arrangements of nozzles 6 and pumps 11. The pumps 11 have a suction side arranged to suck water from the reservoir 3 and to jet it via one or more of the associated nozzles 6. The jetted water falls down onto the floor 2 where it is recollected in the reservoir 3 via openings and open joints in the floor 2.

The outer ends 4A of the tiles 4 are supported by a frame or supports (not shown) at such a level that the power pack 10 is below water level W of a regularly filled reservoir, while the beams 12 with the pumps 11 are below water level W but still at a distance above ground level G.

The floor modules 4 can be mounted on a frame (not shown) above the reservoir 3, such that the suction side of the individual pumps 11 is able to suck water from the reservoir 3.

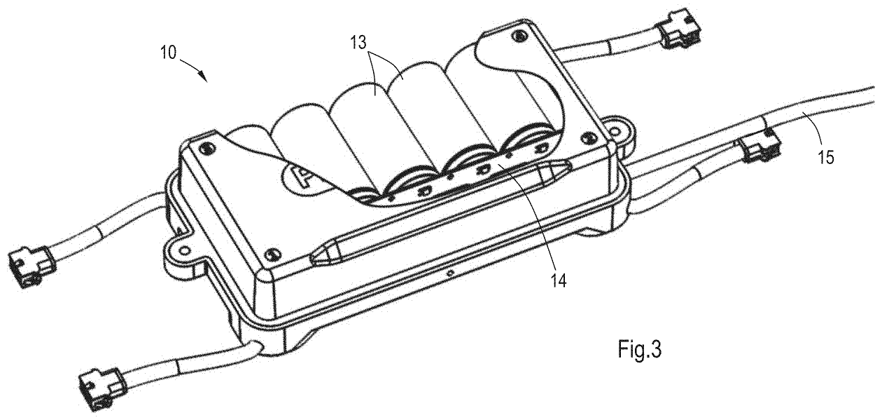

FIG. 3 shows the power pack 10 in more detail, with a part of the water tight housing broken away. The power pack 10 contains five power storage elements, in this exemplary embodiment supercapacitors 13, in a serial arrangement on a circuit board 14. Alternative embodiments may comprise more or less supercapacitors 13 and/or other types of power storage elements and/or may use different arrangements. A central feeding cable 15 comprises a power line 16 and a data line 17. The power line 16 feeds the five supercapacitors 13.

The watertight casing of the power pack also encases a local auxiliary controller 18 on the circuit board 14 connected to the data line 17 of the feeding cable 15. The main controller 8 communicates via the data line 17 with the auxiliary controller 18 of the power pack 10. The auxiliary controller 18 directly controls the connected pumps 11 of the floor module 4 in accordance with instructions from the main controller 8. This way the play fountain 1 is controlled on two levels: the main controller 8 determines the pattern and activates the auxiliary controller 18 of selected floor modules 4. In turn, the auxiliary controller 18 of the floor module 4 activates the pumps 11 or nozzles 6 of that floor module 4 to produce jets of the desired intensity and pulse lengths.

FIG. 4 shows the elements located in the plant room 7. These include the main controller 8, which is connected via a first power cable 19 to the mains or another power source, such as a local power generator. A second power cable 20 runs from the main controller 8 to a power supply unit 21 and subsequently to a junction cabinet 22. The power supply unit 21 reduces the voltage to an operational voltage of the junction cabinet 22, for instance to 12 Volt. A data line 23 runs parallel to the second power cable 20 from the main controller 8 to the junction cabinet 22.

The junction cabinet 22 comprises a series of connection ports configured to receive matching connectors 24 of feeding cables 15 combining power and data lines to the power packs 10 of the individual floor modules 4. All connection ports are operatively connected to the power cable 20 coming from the power supply unit 21 and to the data line 23 coming from the main controller 8, e.g., via a common conductor such as a rails, allowing the power packs to transfer electric energy to each other, bypassing the power supply unit 21.

The junction cabinet 22 comprises a casing 25 with doors 26 shielding the connection ports when the doors 26 are closed off. The casing 25 comprises a security lock 27 locking the casing 25 when the connected power packs 10 are still wholly or partly charged. For example, the assembly may comprise sensors for monitoring if the doors of the junction cabinet are opened or closed. The controller may be programmed to initiate external power supply from the mains or a generator only if the sensors signal that the doors are closed. If the controller receives a signal from the sensors that the doors are open, the controller will block external power supply. The controller can also be configured to monitor the stored energy. Only of the stored energy e.g., the voltage or charge is below a predefined level the controller allows opening of the doors.

Each power pack 10 feeds an indicator lamp 28, which may for example be located on the casing 25. If the junction cabinet 22 is disconnected from the mains the indicator lamp 28 will very slowly exhaust the associated power pack 10. When the indicator lamp 28 goes out, the power pack 10 is sufficiently discharged and the casing 25 of the junction cabinet 22 can be opened safely, e.g., to plug-in a connector of a new or uncharged power pack 10.

The main controller 8 controls recharging of the power packs 10 via the power supply unit 21. Recharging of the supercapacitors can take place during discharging of the supercapacitors. The recharging cycle is of about the same time length as the discharge cycle. Since the supercapacitors are connected via the junction cabinet 22, they will also power each other, like a system of communicating vessels. This way, a very flexible power system is obtained.

The main controller 8 can also be used for controlling lights, sound systems, the water recycling and conditioning system and other possible facilities.

The invention is not limited to the embodiment described above, which can be varied in a number of ways within the scope of the claims.

1. A fountain assembly comprising one or more rechargeable power packs, each power pack comprising at least one power storage element, wherein the fountain assembly further comprises a controller configured to continuously maintain stored power of one or more power storage elements at or above a predefined level during operation.

2. The fountain assembly according to claim 1, comprising a plurality of power packs interconnected so as to allow direct power exchange between the power packs.

3. The fountain assembly according to claim 1, wherein each power pack feeds a plurality of electric motors for controlling water jets, valves for controlling water jets and/or light sources.

4. The fountain assembly according to claim 3, comprising a load bearing floor comprising interchangeable floor modules, each floor module comprising a tile with a plurality of nozzles, each nozzle being operatively connected to a pump or valve, powered by one of the power packs.

5. The fountain assembly according to claim 4, wherein each power pack is operatively connected to an auxiliary controller controlling activation of electric motors and/or valves of the associated floor module.

6. The fountain assembly according to claim 1, wherein at least one of the power packs comprises at least one power storage element storing electric charges.

7. The fountain assembly according to claim 6, wherein the power storage elements include at least one capacitor.

8. The fountain assembly according to claim 7, wherein the at least one capacitor includes at least one supercapacitor or ultracapacitor, such as a double layer capacitor, pseudo-capacitor and/or hybrid capacitor, such as a lithium-ion capacitor, or combinations thereof.

9. A method of operating a fountain assembly comprising one or more rechargeable power packs, wherein the power packs are charged to a level which is continuously maintained during operation.

10. The fountain assembly according to claim 2, wherein each power pack feeds a plurality of electric motors for controlling water jets, valves for controlling water jets and/or light sources.

11. The fountain assembly according to claim 10, wherein at least one of the power packs comprises at least one power storage element storing electric charges.

12. The fountain assembly according to claim 2, wherein at least one of the power packs comprises at least one power storage element storing electric charges.

13. The fountain assembly according to claim 3, wherein at least one of the power packs comprises at least one power storage element storing electric charges.

14. The fountain assembly according to claim 4, wherein at least one of the power packs comprises at least one power storage element storing electric charges.

15. The fountain assembly according to claim 5, wherein at least one of the power packs comprises at least one power storage element storing electric charges.
